(19) United States
(12) Patent Application Publication
(10) Pub. No.: US 2004/0088733 A1
(43) Pub. Date: May 6, 2004

(54) Broadband network test system and method

(76) Inventor: Daniel W. Havens, Fairfield, PA (US)

Correspondence Address: Jeffrey S. Habib, Esq., Thomas Hooker, P.C., Suite 304, 100 Chestnut Street, Harrisburg, PA, 17101, US

(21) Appl. No.: 10/287,353

(22) Filed: Nov. 4, 2002

(51) Int. Cl. H04N 7/173

(52) U.S. Cl. 725/107; 725/111

(57) ABSTRACT

A test system for a CATV transmission system having a headend and a broadband network serving a plurality of nodes enables testing by a field technician without the need for a second technician at the headend. The field technician transmits test commands through the network to a controller connected to the headed that automatically turns on or off individually selectable cable channels in response to the commands.

### FIELD OF THE INVENTION

The invention relates to broadband network systems such as cable TV networks, particularly to a test system for testing signal transmission through the network and a method of transmission testing.

### BACKGROUND OF THE INVENTION

Cable television systems broadcast a number of television (video) channels, audio channels, and data channels. The television channels are received from satellites, on-air broadcast sources, and production facilities maintained by the cable company itself. The separate channels are fed to a headend of the cable system, where the channels are processed, assigned to individual cable channels, and combined into a single signal transmitted through a broadband network to its subscribers.

Many cable systems also enable subscribers to transmit signals upstream to the headend for high-speed Internet access using widely available cable modems.

The Federal Communications Commission requires that cable operators regularly test the quality of the channels transmitted through the network. This “Proof-of-Performance” testing requires testing of four to twenty channels at different locations in the network. Testing may also be necessary to diagnose and correct poor reception or breaks in cable service in response to subscriber complaints.

Tests are conducted by a field technician and are often made at the cable tap outside a subscriber's home. The channels being tested must be turned off at the headend so that the broadcast signal does not interfere with the tests. This requires a second technician at the headend to turn the channels on and off. The use of an additional technician to turn the channels on and off causes testing to be labor-intensive. The two technicians must remain in contact with each other to synchronize switching the channels on and off, and communication delays or dropped radio or telephone connections between the technician in the field and the technician at the headend often significantly increases the time needed to conduct the tests.

Because using two technicians to conduct testing is expensive and inefficient, test systems have been developed to enable a field technician to conduct tests alone. In one test system, a control unit is installed at the headend that turns off a television channel for a brief period during the vertical interval of the television signal. Test signals are inserted during the brief period the channel is off, and a field technician decodes the test signals in the field. The field technician must use expensive test equipment to synchronize the test measurements with the blanked portion of the television signal. Furthermore, the system cannot be used with devices that do not transmit a television signal.

Another test system uses unused cable channels to transmit measurements of other, in-use channels. This system also requires specialized test equipment to receive and decode the signals, and reduces the effective channel capacity of the network.

Thus there is a need for an improved test system for cable TV networks that enables testing by a field technician without a second technician at the headend, and without the need for expensive, specialized test equipment or the loss of channel capacity.

### SUMMARY OF THE INVENTION

The invention is an improved test system for cable TV networks. The improved test system enables testing at a network node without a second technician at the headend, and without the need for expensive, specialized test equipment or the loss of channel capacity.

A test system in accordance with the present invention includes a control apparatus coupled to the headend of the cable network. The control apparatus controls a number of channels in response to test commands transmitted from the field technician at a node to the control apparatus. The control apparatus includes a number of channel controllers, each channel controller associated with a respective channel and inserted into a channel path of the channel for selectively controlling the channel output from the headend during testing. The control apparatus issues signals to the controllers to carry out the test commands. The commands typically include switching channels on or off, or injecting test signals into channels.

In preferred embodiments of the present invention the channel controllers are connected to conventional modulators and signal processors installed at the headend. The channel controllers include relays that, depending on the control circuitry of the modulator associated with each controller, may connect a voltage source, control contact closures or ground a circuit to turn on or off the cable channels at the modulators. In alternative embodiments the channel controllers control in-line RF switches at the modulator outputs to turn on or off cable channels.

The test commands are preferably transmitted upstream through the network from a network node to the control apparatus. If the network is incapable of upstream transmission, a second, separate network (for example, a telephone network) can transmit commands from the node to the control apparatus.

Other objects and features of the invention will become apparent as the description proceeds, especially when taken in conjunction with the accompanying drawings illustrating test systems of the present invention, of which there are three sheets of three embodiments.

### BRIEF DESCRIPTION OF THE DRAWINGS

FIG. 1 is a schematic view of a broadband network incorporating a test system of the present invention;

FIG. 2 is a view similar to FIG. 1 of the test system;

FIG. 3 is a schematic of a control switch shown in FIG. 1;

FIG. 4 is similar to FIG. 3 but illustrates a second embodiment control switch that incorporates a second function; and

FIG. 5 is similar to FIG. 2 but illustrates a third embodiment test system having alternative upstream communication paths in accordance with the present invention.

### DESCRIPTION OF THE PREFERRED EMBODIMENTS

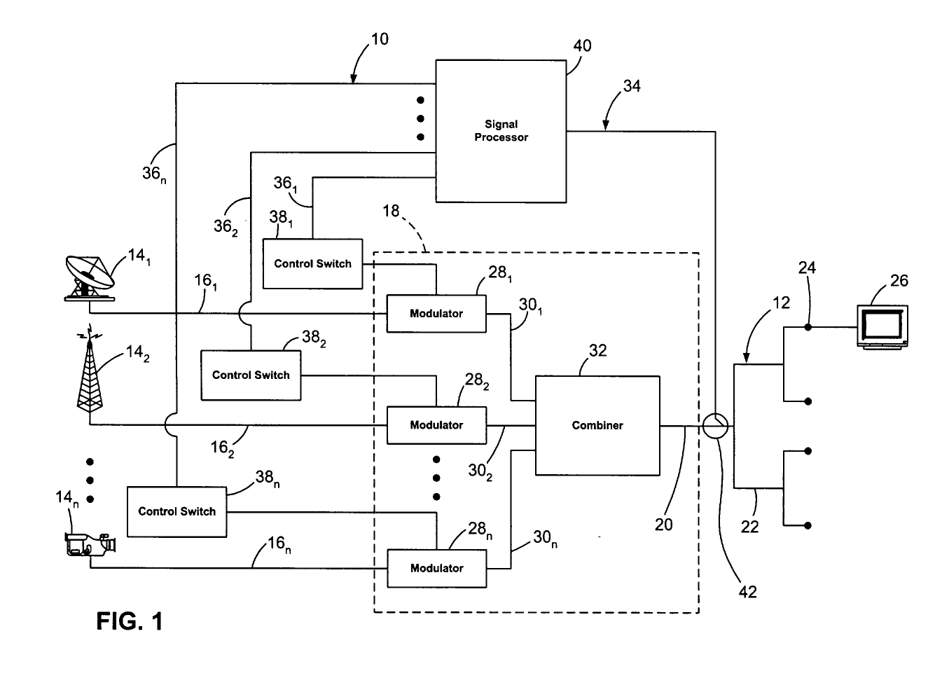

FIG. 1 illustrates a broadband test system 10 in accordance with the present invention employed for testing a conventional broadband CATV network 12. The network 12 has a number of video sources 14₁, 14₂, . . . 14ₙ, that supply video channels 16₁, 16₂, . . . 16ₙ into cable headend 18. The headend 18 combines the separate video channels 16 into a single radio-frequency (RF) broadband signal 20 transmitted downstream from the headend through a broadband network 22 to a number of nodes 24, typically taps located outside of cable subscribers' homes. Cable service is provided to a subscriber by connecting the in-home electronics 26 (for example, a television) to the tap 24.

The headend 18 includes a number of conventional modulators 28₁, 28₂, . . . 28ₙ that process the input channels 16. Each modulator 28 is in the channel path of a respective channel 16 and outputs a signal 30 at a different CATV channel. The individual channel signals 30 feed into a combiner 32 that combines the channel signals 30 into the single broadband signal 20.

The headend 18 also includes preamplifiers, demodulators, frequency converters and other signal processing equipment (not shown), including equipment that enables signals to be transmitted through the network 22 upstream from each node 24 and downstream from the headend for broadband Internet access.

The broadband network 22 is a “tree and root” type network, but other conventional network topologies, such as hybrid-fiber-coax (HFC) or “star” topologies, can be used with the present invention. The broadband network can be formed from coaxial cable, optical fiber cable, or a combination of both.

The test system 10 controls the output of the headend in response to signals representing test commands transmitted upstream through the network by a field technician located at a node. The test system 10 includes a control apparatus 34 coupled between the headend 18 and the network 22. The control apparatus receives the signals representing the test commands and controls the headend in response to the test commands. The control apparatus 34 controls the headend via a number of channel controllers 36 that each controls the output of a respective channel 30. The number of channel controllers 36 will typically be less than the total number of channels carried by the cable TV system; that is, not every channel necessarily needs to have a channel controller associated with it.

Each channel controller 36 is in the channel path of its associated channel and, in the illustrated embodiment, includes a control switch or channel switch 38 that turns on or off the channel's video carrier in response to the test commands. This enables the technician to turn off a channel for testing and turn it back on without the need of a second technician at the headend.

The control apparatus 34 also includes a signal processor 40 that processes the commands received through the network and issues commands to the channel controllers for turning on or off the selected channels. The signals are transmitted to the signal processor via an extraction connection 42 coupled to the network that extracts the signals from the network and transmits them to the signal processor for processing.

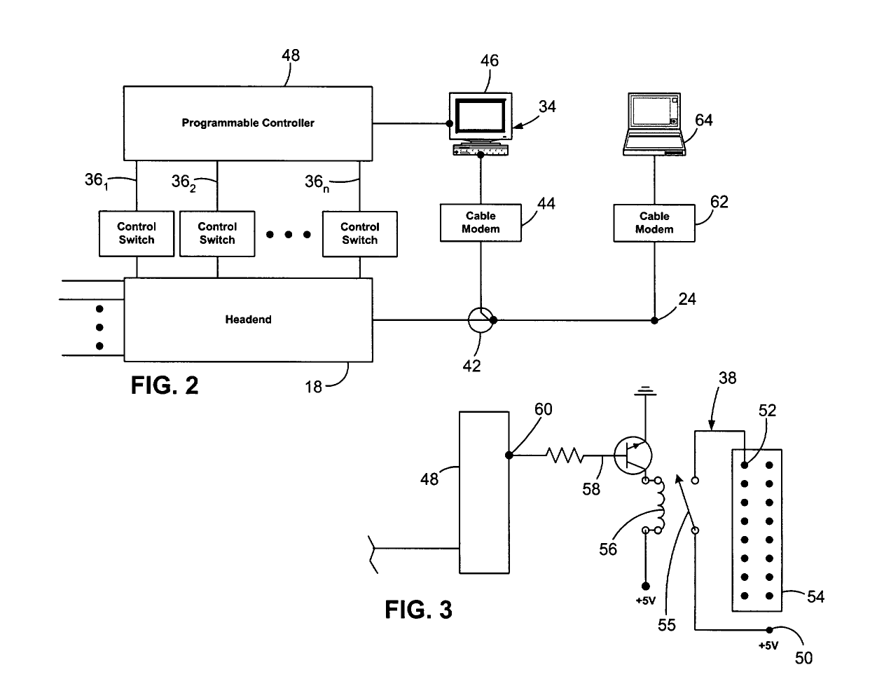

FIG. 2 illustrates the major hardware components of the control apparatus 34, which includes an upstream cable modem 44 at the connection 42. The modem receives the command signals from the network and transmits them via cable to the signal processor 40. The signal processor includes a computer 46 connected via a network port to the cable modem 44. The computer 46 may be a personal computer running the WINDOWS, MACINTOSH or LINUX operating systems.

The computer 46 receives and processes the signals from the modem to determine the test commands, and controls a programmable micro-controller 48 connected to each of the channel controllers 36. The computer communicates with the micro-controller via a serial connection to carry out the test commands. Communicating with and controlling a micro-controller via the serial port of a computer is well known and so will not be described further. The supporting circuitry needed for operating the micro-controller 48 is conventional and for clarity is not shown. The micro-controller processes the commands received from the computer and controls the channel controllers 36 in response to the commands. The micro-controller 48 may be a PIC 16F84 or equivalent.

In the illustrated embodiment, circuitry incorporated in the modulator 28 forms part of the channel controller 36 associated with the modulator. Commercially available modulators typically include a port that turns off the channel if a voltage is present at the port or if a contact closure is made. The channel controller 36 makes use of this modulator circuitry to turn the channel on or off. The control switch 38 is placed in series with the modulator port and includes an electrical circuit that extends from an output port of the micro-controller 48 to the modulator port. If the modulators do not support turning on or off channels, the channel controllers can open or close RF switches placed in the channel path away from the modulators. Such RF switches would preferably be located at the output of the modulators.

The illustrated micro-controller 48 has eight program-controllable output ports and can control eight separate channel controllers 36. If additional channel controllers are needed, the micro-controllers can be daisy-chained via the serial connection. Each micro-controller would be individually addressable by the computer.

FIG. 3 illustrates the circuitry of one of the control switches 38. The illustrated control switch is connected to a modulator having a port that turns off the channel if a defined voltage is present at the port. The circuit has a voltage source 50 operatively connected to the modulator port through a pin 52 of a cable header 54 (each control switch 38 is connected to a respective pin of the cable header 54). A cable (not shown) connected to the header 54 jumps to a secondary PC terminal board (not shown) that includes the appropriate terminal or connector to connect with the modulator port. The voltage is applied or removed through a normally open switch 54 controlled by a relay coil 56. The relay coil 56 is controlled via a control line 58 connected to the output port 60 of the micro-controller. When the port 58 goes high and outputs a +5 volts DC voltage, the coil is energized, switch 55 closes, and voltage is presented at the modulator port to turn the channel off. When the port 58 goes low, the coil is de-energized, switch 55 opens, and the channel is turned back on.

Use of the test system 10 will now be described. A field technician located at a node 24 connects a downstream cable modem 62 (see FIG. 2) to the network to transmit signals upstream to the control apparatus 34. Test commands are input via a portable computer 64 or other portable data input device, ordering the control apparatus 34 to turn off one or more selected channels. The signals representing the test commands are extracted from the upstream cable modem 44 and transmitted to the computer 46. Computer software processes the signals and directs the micro-controller 48 to turn off the requested channels. The micro-controller actuates the necessary output ports 58 to turn off the requested channels. The technician can then test the turned-off channels in a conventional manner, without the need for equipment that synchronizes with a video signal. After testing is completed, the channels are turned back on. The entire process is under the control of the field technician and does not require the assistance of other technicians at the head end.

In the illustrated embodiment the software on the computer 46 communicates through the network 22 with software on the portable computer 64. The software on the portable computer 64 can remotely operate software on computer 46, or can be a “front end” program that presents a desired user interface to the technician and communicates with a program on the computer 46.

In yet other embodiments the computer 46 can be configured as a web server having an IP address on the network 22. The portable computer 64 runs a web browser application that communicates with the server through the network 22 for controlling the headend.

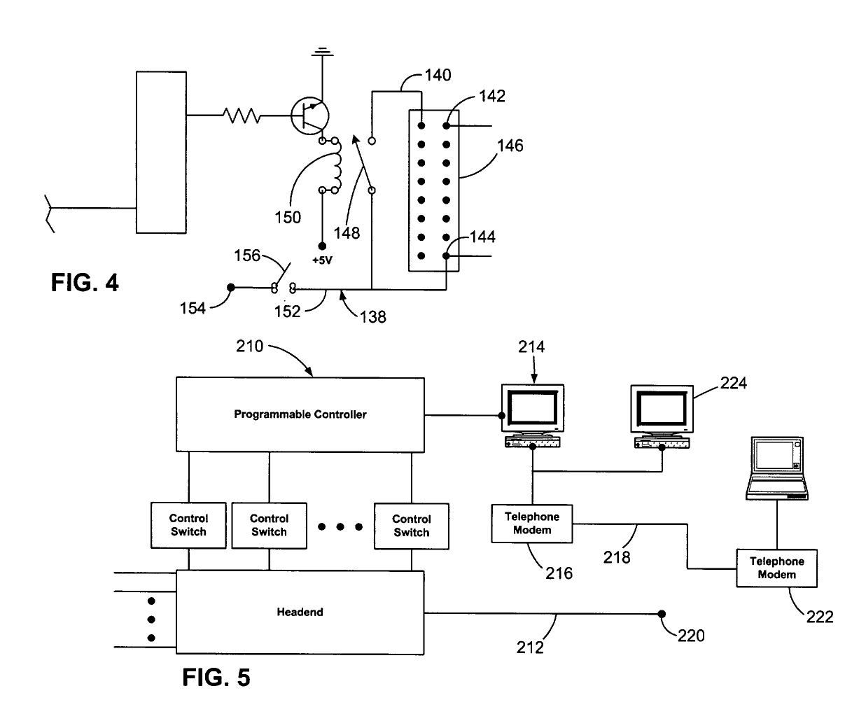

FIG. 4 illustrates a second embodiment control switch 138. The control switch 138 is similar to the control switch 38 and only the differences will be discussed. The control switch 138 is connected to a modulator having a port that turns off the channel when a short-circuit is present at the port. The control switch is connected to the modulator via a control circuit 140 connecting header pins 142, 144 of a header 146 like the header 54. The circuit 140 is opened and closed by a switch 148 controlled by the relay 150. When the switch 148 is closed, circuit 140 is short-circuited and the modulator channel is turned off. When the switch 148 is open, the channel is turned on.

The control switch 138 includes a second control circuit 152 connected to a source terminal 154 that enables the switch 138 to selectively perform a second, alternative test function. The source terminal 154 can be a voltage source, a ground connection, or a test signal source such as a Vertical Interval Test Signal (VITS). Operation of the second control circuit 152 is controlled by a switch 156 that interconnects the circuit 152 to the circuit 140. When the switch 156 is open, the circuit 140 operates as described above. When the switch 156 is closed, the source terminal 154 is connected to the modulator via the circuit 140. The switch then 148 acts to connect and disconnect the source terminal 154 from the modulator. Each individual switch 156 can be configured as desired for its associated modulator.

A given network test system can include both control switches 38 and control switches 138 configured in ways to achieve desired test functions for the channels to be tested. For example, control switches associated with video channels may have video-related functions and control switches associated with digital audio channels may have audio-related functions. The computer 46 or micro-controller 48 may also directly control these functions in response to test commands.

FIG. 5 illustrates a test system 210 similar to test system 10 for use on a cable network 212 that is not capable of upstream transmissions. The control apparatus 214 is otherwise identical to the control apparatus 34 except that the upstream modem 216 is adapted to receive signals from a second network. In the illustrated embodiment the modem 216 is a telephone modem connected to the telephone network 218. The field technician at a cable node 220 connects a downstream telephone modem 222 to the telephone network for communication with the control apparatus 214. The telephone network, rather than the cable network, communicates the test commands to the control apparatus. The telephone network can be a wireless network.

FIG. 5 also illustrates another second network path. A computer 224 located in a billing or administrative office located at the cable headend communicates through a telephone modem (not shown) with the technician modem 222. The test commands are transmitted through a LAN network connected to the signal processing computer of the control apparatus 214. Alternatively, personnel at the office can view the commands at the computer 224 and in turn send commands to the control apparatus 214. Although this requires a person at the computer 224, the person does not have to be a technician.

While I have illustrated and described preferred embodiments of my invention, it is understood that these are capable of modification, and I therefore do not wish to be limited to the precise details set forth, but desire to avail myself of such changes and alterations as fall within the purview of the following claims.

What I claim as my invention is:

1. A test apparatus for a CATV transmission system having a headend and a broadband network serving a plurality of nodes, the network capable of transmitting signals downstream from the headend to the nodes and transmitting signals upstream from the nodes towards the headend, the headend having a plurality of modulators, each modulator associated with a respective channel transmitted through the network, the test system comprising:
means for manually inputting test commands and injecting signals representing the commands into the network for upstream transmission through the network from a node;
a control apparatus operatively coupled between the headend and the network to control the headend in response to the test commands, the control apparatus comprising:
(a) a plurality of channel controllers, each controller operatively coupled to a respective modulator for controlling the modulator in response to test commands received by the controller;
(b) a signal processor coupled to the channel controllers for processing data representing the test commands and transmitting signals representing test commands for the appropriate channel controllers that will carry out the commands; and
(c) means for extracting the signals transmitted upstream through the network and transmitting data representing the signals to the signal processor;
whereby a field technician can selectively control channels from a node during testing without the assistance of a second technician at the headend.

2. The test apparatus of claim 1 wherein the means for extracting signals comprises a first modem operatively connected to the network to receive the upstream signals.

3. The test apparatus of claim 2 wherein the means for injecting signals comprises a second modem operatively connected to the network at the node.

4. The test apparatus of claim 1 wherein the signal processor comprises a computer connected to the network for processing the data representing the test commands.

5. The test apparatus of claim 4 wherein the signal processor comprises a micro-controller coupled between the computer and each of the modulator controllers, the micro-controller being adapted to receive and process data from the computer and transmit commands to the appropriate modulator controller.

6. The test apparatus of claim 1 wherein each channel controller is adapted to selectively switch its associated modulator between one of a first operating state wherein the channel associated with the modulator is on and a second operating state wherein the channel associated with the modulator is off in response to the commands received by the signal processor.

7. The test apparatus of claim 6 wherein each channel controller comprises an electrical connection to its associated modulator to selectively switch the modulator between first and second operating states.

8. The test apparatus of claim 6 wherein each electrical connection comprises a relay mechanism that selectively opens and closes the electrical circuit to switch the modulator between first and second operating states.

9. The test apparatus of claim 1 wherein each channel controller comprises means for carrying out an alternative signal function.

10. The test apparatus of claim 9 wherein the means for carrying out an alternative function comprises means for inserting at least one of a voltage source, a vertical interval test signal, or an electrical ground.

11. The test apparatus of claim 1 wherein each channel controller is adapted to selectively turn on and turn off the output of the modulator in response to commands received by the modulator controller;
the means for injecting signals comprises a first modem operatively connected to the network at the node; and
the signal processor comprises a second modem operatively connected to the network for receiving the upstream signals, a computer connected to the second modem for processing the signals and determining the commands to be sent to the channel controllers, and a micro-controller coupled between the computer and each of the modulator controllers, the micro-controller being adapted to receive and evaluate signals from the computer and transmit commands to the appropriate channel controller to selectively turn on or turn off the output of the modulator connected to the controller.

12. A test system for a CATV transmission system having a headend and a broadband network serving a plurality of nodes, the headend receiving source channels and supplying a signal to the network for transmitting the channels through the broadband network to the nodes, the test system comprising:
a control apparatus operatively coupled to the headend for controlling a plurality of channels in response to test commands, and means for transmitting signals representing the test commands from a node to the control apparatus;
the control apparatus comprising:
(a) a plurality of channel controllers, each channel controller associated with a respective channel and operatively inserted into a channel path of the channel through the headend for selectively controlling the channel output from the headend during testing; and
(b) means for receiving the transmitted signals and issuing commands represented by the signals to the controllers that will carry out the commands;
whereby a field technician can selectively control the headend output of each of the plurality of channels for channel testing at a node without a second technician at the headend.

13. The test system of claim 12 wherein the means for transmitting signals comprises a second transmission path separate from the broadband network.

14. The test system of claim 13 wherein the second transmission path comprises a telephone network.

15. The test system of claim 14 wherein the second transmission path comprises a local area network.

16. The test system of claim 12 wherein the headend includes a plurality of modulators, each channel having a channel path through a respective modulator, and each channel controller is operatively connected to a respective modulator for opening and closing the channel path through the modulator.

17. A method of testing a CATV transmission system having a headend and a broadband network serving a plurality of nodes, the headend receiving source channels and supplying a signal to the network for transmitting the channels through the broadband network to the nodes, the method comprising the steps of:
(a) transmitting signals representing test commands from the node to a control apparatus operatively connected to the headend;
(b) processing the signals at the controller for controlling a plurality of channel controllers in response to the test commands, each channel controller associated with a respective channel for selectively controlling the channel output from the headend; and
(c) activating at least one controller for controlling the channel output of the channel associated with each activated controller; and
(d) testing a channel while the controller associated with such channel is activated.

18. The method of claim 17 wherein activating a controller comprises turning off the channel associated with such controller.

19. The method of claim 18 wherein the headend includes a plurality of modulators, each modulator associated with a respective channel, and further wherein the step of activating a controller comprises transmitting a signal to its associated modulator to turn off the channel.

20. The method of claim 17 wherein the step of transmitting signals comprises transmitting signals upstream through the network from the node.

21. The method of claim 20 wherein the step of transmitting upstream signals comprises using a cable modem to inject signals into the network.

22. The method of claim 21 wherein the step of transmitting signals to the control apparatus comprises using a cable modem to extract the signals from the network.

23. The method of claim 17 wherein the step of activating a controller inserts a vertical interval test signal into the channel.

24. The method of claim 17 wherein the step of processing the signals comprises inputting the signals to a computer.

25. The method of claim 17 wherein the step of activating a controller comprises using a micro-controller to drive respective controllers.

26. The method of claim 17 wherein the step of processing the signals comprises inputting the signals to a computer and the step of activating a controller comprises transmitting a command signal to a micro-controller to drive the controllers.
